(19) United States
(12) Patent Application Publication
(10) Pub. No.: US 2012/0205415 A1
(43) Pub. Date: Aug. 16, 2012

(54) SYSTEM FOR THE COMPARTMENTALIZATION OF OBJECT CARRYING CABINS

(76) Inventor: Tiffany Abdullahi, Lewisville, TX (US)

(21) Appl. No.: 13/025,115

(22) Filed: Feb. 10, 2011

(51) Int. Cl. B60R 7/00

(52) U.S. Cl. 224/539

(57) ABSTRACT

The present invention is related to a system for the compartmentalization of object carrying cabins, such as car trunks, drawers, containers, or any similar kind of object, in order to utilize the allotted capacity of the given object carrying cabin in accordance with the needs and convenience of the user. This invention presents a system with a plurality of panels connected to each other in either a parallel or perpendicular pattern. The claimed system has protruding locking elements attached to the edges of the panels at either a right (90 degree) or straight (180 degree) angle. The panels are connected by inserting the protruding locking elements of one panel into one of the multiple slots located on the sides of another panel. The slots are fitted to the size of the protruding locking elements and the arrangement of the locking members and the slots in perpendicular and parallel directions determines the pattern of the connection.

### FIELD

The present invention relates generally to a system for compartmentalization of object carrying cabins having a plurality of interlocking panels. More specifically, this invention relates to a system for separating object-carrying cabins into several compartments of various adjustable sizes. The object-carrying cabins may include, but are not limited to, a car trunk and a drawer organizer. The invention may allow the user to easily adjust the pattern and the sizes of the compartments to best suit the user's needs. The invention may also allow for safer storage and transportation of various fragile goods.

### BACKGROUND

The approaches described in this section could be pursued but are not necessarily approaches that have been previously conceived. Therefore, unless otherwise indicated herein, the approaches described in this section are not prior art to the claims in this application and are not admitted to be prior art by inclusion in this section.

Generally, an object-carrying cabin, such as a car trunk organizer, may include boxes or compartments for storage of various goods. These boxes or compartments take considerable amount of space and may limit the user's ability to adjust their sizes to fit a particular piece of cargo. Various related publications are discussed hereinafter.

U.S. Pat. No. 4,171,078 teaches about an adjustable storage rack, mounted inside an automobile trunk and including front and rear hanger assemblies each comprising a pair of transversely-spaced brackets attached to the trunk upper wall and interconnected by straps. Wherein the hanger assemblies provide support for longitudinally disposed, telescopically-related rails providing bearing surfaces for stored articles. The rack is adjustable lengthwise, width-wise and can also be adjusted with respect to the elevation of the rails.

Another U.S. Pat. No. 4,684,087 talks about the holder, made up of at least partially tubular components which include rails, upper end cross members and corner supports as parts of a kit to be assembled by locking keys into keyways. Upper rails join the upper end cross members together in rectangular-like form. Lower rails join corner supports together, the far ends of the corner supports having keys which fit into keyways of the upper end cross members, the corner supports being L-shaped. Each corner support has a key at a smaller diameter end and a keyway at a larger diameter end. Each rail has a key at each end. Corner supports and upper end cross members are each of one piece. Rails may be of two parts which may be screwed or otherwise fastened together, or they may exist as separate pieces in the kit adapted to be put together when the whole grocery bag holder is assembled from kit parts.

Further, U.S. Pat. No. 4,832,242 provides knowledge about the portable automobile boot organizer, which is provided for storing, organizing and transporting jumper cables, first-aid kit, flares, motor oil, other automotive fluids, flashlight and miscellaneous tools. The organizer includes a top lid which attaches to the underside of the boot lid, and has mounts for jumper cables, first-aid kit and flares. The top lid has a pair of mating flanges for complementary alignment with the bottom tray when the boot is closed. Wherein the bottom tray has separate recesses for storage of opened or closed containers of motor oil, brake fluid and sundry tools. Disposed at each corner, four threaded rods are situated to adjust the tray height into abutting cooperation with the top lid. The patent is related to storing and transporting of roadside emergency accessories in a car boot.

Another U.S. Pat. No. 5,234,116 talks about a collapsible and expandable framework provide spaced, side-by-side compartments, accessible from overhead to place packages or bags is described. The collapsible and expandable frame can be extending linearly providing for compartments of greater size or collapsed linearly for providing compartments of lesser size. The collapsible and expandable frames are adjustably positionable, depending upon a particularly chosen size to correspond to packages or bags to be held. Hooks on a top end of the frames are utilized for purposes of holding handles to grocery bags to prevent the bags from toppling over. The patent is useful in vehicles to prevent the packages or bags from rolling around in the vehicle during its movement.

Further, U.S. Pat. No. 5,520,316 is disclosing a rack. The said rack comprises two supporting bars each having a sliding track defined in an open top side and two bracing bars, each bracing bars being slidably received with both of the supporting bars such that the distance between the bracing bars is variable. There are holding pieces, forming a number of holding areas bounded by the holding pieces. There are sliding pieces, each of the holding pieces being supported by at least one of the sliding pieces, the sliding pieces being inserted into the sliding track such that a distance between one of the bracing bars and one of the holding pieces is variable, as is a distance between any two of the holding pieces so that the size of each of the holding areas is variable. Each bracing bar has a pair of connecting sliding bars slidably received in the supporting bars and member for fixing at least one of the connecting sliding bars relative to the supporting bars comprising a screw knob dressed with a tightening washer. The advantage of the patent is a storage rack for automobile trunks, which can be readily installed in typical automobile trunk, may be used to secure objects of different sizes, thereby preventing these objects from being damaged during transportation.

Further, U.S. Pat. No. 5,713,502 describes a collapsible truck spacer comprising a rectangular collapsible carrier unit including a carrier member having rigid end panels. There is a pair of opposing flexible, collapsible side walls, an open top, and a collapsible bottom. The open top is defined by upper peripheral edges of the end panels and the side walls. An extensible telescoping support unit is operatively connected to the end panels and operatively associated with the collapsible side walls such that the unit extends parallel to the upper edges of the side walls for deploying the collapsible carrier unit into a fully extended mode. The general width dimension of the carrier can be fixed and an adjustable length can be varied to accommodate a user's particular needs.

Another patent U.S. Pat. No. 5,961,171 teaches specific holding articles used within a vehicular trunk firmly without sliding movement during vehicular running by means of a partition member provided in said trunk. According to the vehicular trunk partitioning device of the invention, the partition member is attached on one side thereof to the floor or a side wall of a vehicular trunk so as to be pivotable around the one side. The partition member is urged pivotally toward the floor or the side wall of the trunk around the one side. Preferably, the partition member can extend and retract in a telescopic fashion.

U.S. Pat. No. 6,041,987 describes an organizer frame assembly. The organizer frame assembly comprises upper inner and outer telescopic tubes bent to form four support legs to which are bolted two lower telescopic tubes having the same plan shape. The two frame parts are spring biased apart to fit against the sides of the trunk. Cargo divider plates slidably mounted on the frame tubes are conveniently lockable by means of wing screws in any position. It is used for separating and holding different kinds and shapes of cargo items. It prevents load items shifting in the vehicle. The two part spring biased frame is easily and automatically installed to fit snugly and tightly in the trunk. The organizer is simple, inexpensive and easy to use.

U.S. Pat. No. 6,109,847 educates about a telescopic cross element. The telescopic cross element connected between end supports, is adjusted to variable lengths to fit into different sized cargo areas. An intermediate support of the cross element provides additional lateral support and rigidity. An optional accessory holder is attached to the organizer, to hold safety items. Reflectors are also provided to the organizer to improve visibility. For telescopically adjusting vehicle cargo areas such as a truck and helping users to efficiently plan and store items such as bags of groceries, files or automotive items. Since the cross element items with variable adjustment end support and the intermediate supports are removable, the organizer is easily expanded or collapsed to fit within different space requirements of vehicle cargo areas and also it is possible to facilitate easy disassembly for storage purposes or for transfer to another vehicle cargo area. Further, as an optional accessory holder is provided to the organizer, safety items are provided on the organizer to eliminate or diminish dangerous situations. Further, as reflectors are also provided to the organizer, the visibility is improved to warn approaching motorist of disabled vehicle.

U.S. Pat. No. 6,186,379 teaches about a fixture comprises a frame which is adjustable in size and is placed on the floor of the car-boot. A base-mat which is impervious to liquid is placed so that it is watertight or has upward bent rims, on the frame. The base-mat possesses a high coefficient of friction. The frame has profiled bars joined by angled pieces and which can be telescoped and locked on the arms of the angled pieces. The frame has luggage-supports extending vertically upwards from it and detachably positioned on it. It protects car boot from being dirtied by loose goods or liquid falling over.

U.S. Pat. No. 6,796,472 discloses an interconnected assembly with slidable shafts and shaft housings, placed to the lateral connection flanges of an automobile trunk to form multiple compartments. The slidable shafts are connectable to corresponding lateral connection flanges by lockable pins. The patent secures cargo loaded inside trunk, enables quick and easy changing of compartment configuration, forms variable number of compartments and ensures convenient retrieval of cargo from trunk.

Further the U.S. Pat. No. 7,028,872 talks about two opposite sides of the pockets provided with a dimensionally stable support section extending over the entire length of said sides. The opposite ends of the support sections are releasably securable inside holders in the boot space. The support sections are connected via at least one fold region in the bottom of the pocket. The boot space can be easily divided up into many different storage space configurations.

Further, U.S. Pat. No. 7,121,601 teaches that a flexible cargo retainer has one end secured in a cavity of a vertical trim panel while another end is secured to the end panel. The retainer extends from the cavity and to the end panel to form a cargo receiving space when end panel is deployed from the trim panel. The retainer collapses into the cavity to be hidden from view when the end panel is stowed in the trim panel. It enables reliable securing of varying types and sizes of cargo with storage system optionally removable to facilitate loading and unloading of cargo.

U.S. Pat. No. 7,794,004 talks about a system having a cargo bin lining comprising an upper side forming a cargo floor of a vehicle. Storage compartments extend laterally across the vehicle. Lids are arranged over openings of the storage compartments. A side lining comprises a front side forming a lateral interior wall of the vehicle. A side compartment is recessed from the front side of the side lining. A side compartment lid is arranged over an opening of the side compartment and is selectively openable for providing access to the side compartment. The storage compartments are oriented in front-to-back relation relative to one another and extend laterally across the entire width of interior of the vehicle, and the side storage compartment is arranged laterally along an entire length of the storage compartments, so as to maximize storage space provided by the cargo system.

Looking into above said prior arts, space for some improvements over the existing compartmentalization techniques is visible. There is a need for an easier and faster way to compartmentalize and re-compartmentalize a trunk, drawer, or other object carrying cabin without the need of separate attachment pins. Additionally, greater user control of the unit dimensions is needed, including flexibility in creating the number of compartments and an ability to adjust compartment sizes in both length and width to create a safer environment so that the items being carried in the trunk, drawer, or cabin do not get displaced during movement.

### SUMMARY

This summary is provided to introduce a selection of concepts in a simplified form that are further described below in the Detailed Description. This summary is not intended to identify key or essential features of the claimed subject matter, nor is it intended to be used as an aid in determining the scope of the claimed subject matter.

The present disclosure is related to a system having a plurality of interlocking panels which can be used in separating object-carrying cabins into several compartments of various adjustable sizes. The system comprises a collection of panels, which interconnect in a parallel and/or perpendicular pattern by sliding the protruding locking element, which can be attached at either a straight (180 degree) or right (90 degree) angle to one edge of the panel using any of the number of corresponding vertical slots, which are fitted to the shape of the locking element, on the sides of another panel.

The characteristics and utilities of the sample representation described in this summary and the detailed description below are not exclusive. Many additional features and advantages will be apparent to one of ordinary skill when provided with the following drawings, specifications and claims.

### BRIEF DESCRIPTION OF DRAWINGS

The drawings presented for the description of the invention are example representations of the preferred embodiments and arrangements of the invention and are not intended to limit the scope of the invention. The scope of the invention is limited only by the means of claims presented.

Embodiments are illustrated by way of example and are not limited by the figures of the accompanying drawings, in which like references indicate similar elements and in which:

FIG. 1 is a schematic view of a system for the compartmentalization of object carrying cabins, in accordance with an exemplary embodiment.

FIG. 2 is a schematic view of an interconnection of arrangement patterns of a system for the compartmentalization of object carrying cabins, in accordance with an exemplary embodiment.

FIG. 3 is a schematic prospective view of an individual panel in a system for the compartmentalization of object carrying cabins, in accordance with an exemplary embodiment.

FIG. 4 is a schematic prospective view of another individual panel in a system for the compartmentalization of object carrying cabins, in accordance with an exemplary embodiment.

### DETAILED DESCRIPTION

Exemplary embodiments are described. In the following description, for purposes of explanation, numerous specific details are set forth in order to provide a thorough understanding of exemplary embodiments. It will be evident, however, to one skilled in the art, that the present invention may be practiced without these specific details.

The description of the invention provided below is an example explanation of the claimed system through preferred embodiments of the invented system and is not intended to limit the scope of the invention in any manner. The scope of the invention shall be construed strictly by the claims, and any kind of description by the way of example and by the way of construction or arrangement of the embodiments shall be considered as an example and should not be taken as the limitation of the invention.

In some exemplary embodiments, a system for the compartmentalization of object carrying cabins allows compartmentalizing of the trunk of a vehicle, provides structure to the vehicle trunk and minimizes the shifting of items in the trunk during travel. The system is adjustable so that the number of compartments and the compartment sizes can be selected by the user. The system can include several rigid, flat, intersecting panels. Each panel includes various slots on both sides and may have one or two locking mechanisms on one or more ends of the panel. The locking piece of one panel can be inserted into the slot of an intersecting panel. Locking pieces can either form parallel connections or perpendicular connections.

In one exemplary embodiment, a system may be assembled out of three or more panels so that the panels interlock and support the weight of each other. At least three panels should have locking pieces for perpendicular extensions. All panels must have at least one slot on both sides of the panel. Addition of more panels allows for more compartmentalization. Additionally, having more slots on both sides of the panels may allow the user more flexibility in determining number and sizes of compartments. Each panel may add to the structure of the organizer and contribute to the added compartmentalization of the trunk. Furthermore, the system may be fully adjustable in length and width and number of compartments.

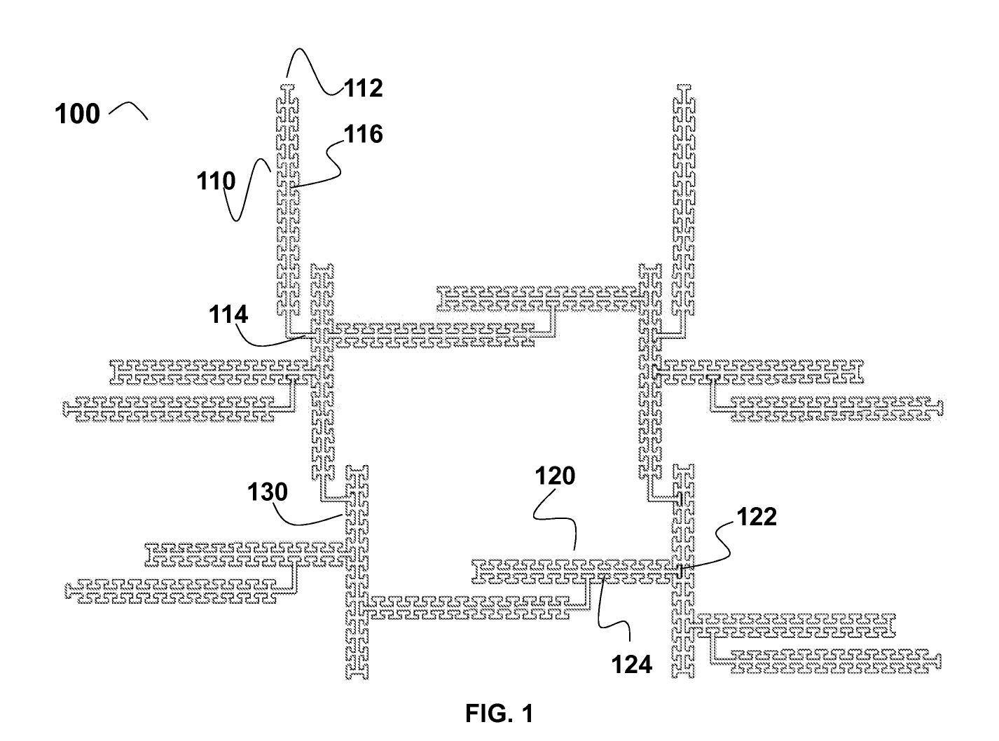

FIG. 1 is a schematic representation of a selected embodiment of the system 100 used for the compartmentalization of object carrying cabins like trunks and other similar kind of objects. As shown, the system 100 is constructed using a plurality of connector panels of three different types. The first type of connector panels is a parallel connector panel 110 having a perpendicular connector 114 at its first end and a parallel connector 112 at its second end. The perpendicular connector 114 forms a right angle with respect to its parallel connector panel 110 in order to be able to attach the parallel connector panel 110 to a side of another panel of any of the three types of connector panels described herein in a parallel arrangement. The parallel connector panel 110 may be connected to another panel by sliding the perpendicular connector 114 into a slot of that panel such as a slot 124 of perpendicular connector panel 120 described below. It will be understood that such arrangement is not exclusive and the parallel connector panel 110 may also be locked into a perpendicular arrangement by using the parallel connector 112 located at the other end of the perpendicular connector panel 110. Thus, the name of the parallel connector panel 110 is derived from a possibility of being arranged in a parallel pattern.

The second type of connector panels shown if FIG. 1 is the perpendicular connector panel 120 having a parallel connector 122 at its first end and no connector at its second end. The parallel connector 122 is straight, thus being able to attach the perpendicular connector panel 120 to another panel of any of the three types described herein in a perpendicular arrangement. When attached to another panel, the parallel connector 122 and the other panel are placed perpendicularly with respect to each other and locked by sliding the parallel connector 122 into a slot of the other panel such as a slot 116 of the parallel connector panel 110 described above. The slot may be located on either side of the other panel and fitted to the shape of the parallel connector 122. The third type of connectors is a connector panel 130 having no connectors at either of its ends but having slots available for connections to parallel connector panel 110 and/or the perpendicular connector panel 120.

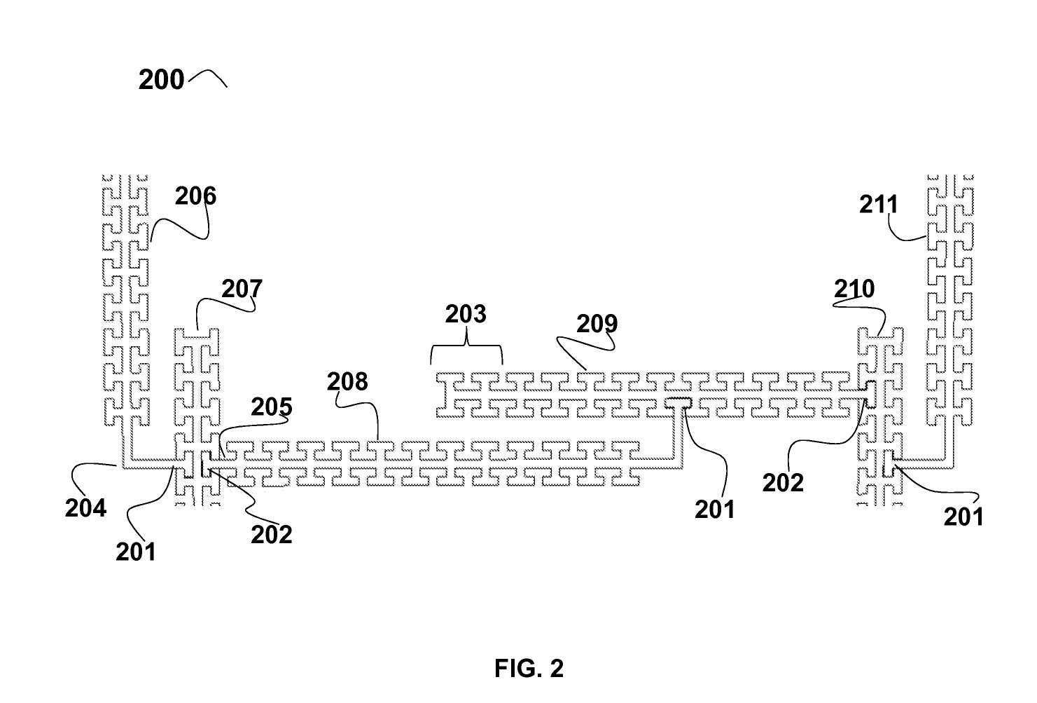

FIG. 2 is a schematic view of an interconnection of arrangement patterns of a system 200 for the compartmentalization of object carrying cabins, in accordance with an exemplary embodiment. FIG. 2 shows a plurality of parallel and perpendicular connector panels. A connection 201 represents a parallel connection pattern with connector panel pairs 206/207, 208/209, and 210/211 being connected by inserting a protruding locking element 204, attached to the edge of the panels 206, 208 and 211 at a right (90 degree) angle, into a slot on the side of the corresponding connector panels 207, 209, or 210, respectively. A connection 202 represents a perpendicular connection pattern with connector panel pairs 207/208, 209/210, being connected by inserting protruding locking element 205, attached to the edge of the connector panels 208 and 209 at a straight (180 degree) angle, into a slot, fitted to the shape of protruding locking element 205, on the side of the corresponding connected panel 207 or 210, respectively. Connections 202 are such that the position of the connector panels 208 and 209 remains perpendicular to the connector panels 207 and 210. As mentioned above, a connector panel having a protruding locking element can be of two forms, one having protruding locking members at both of its ends and one having protruding locking elements only at one of its ends. For example, the connector panel 208 has protruding locking elements at both of its ends and panel 209 has a protruding locking element only at one of its ends.

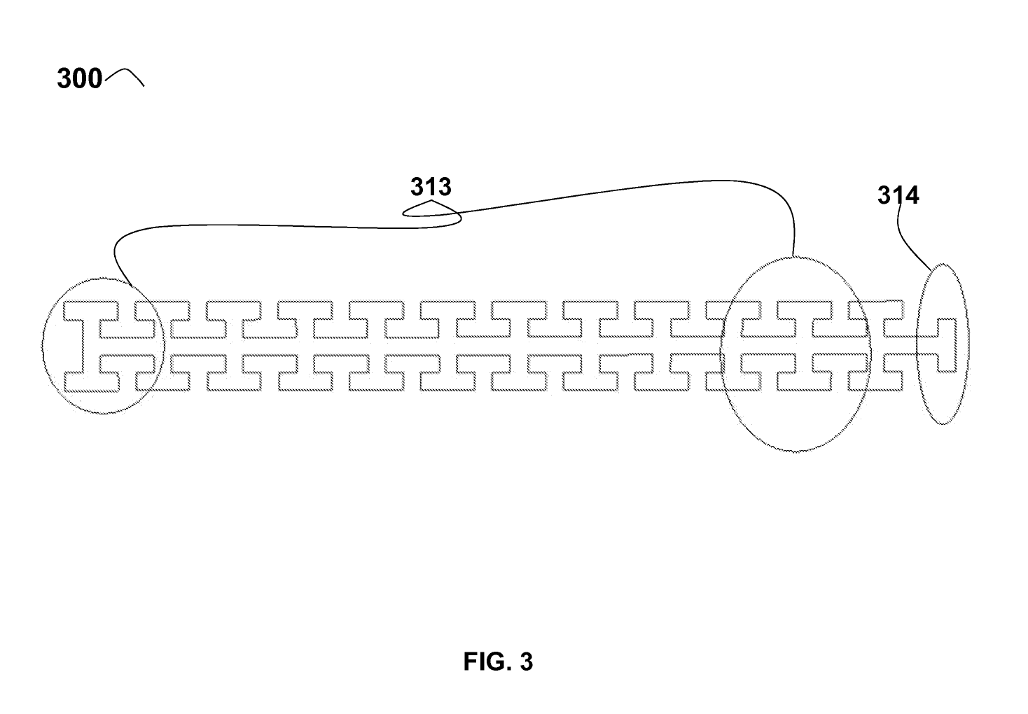

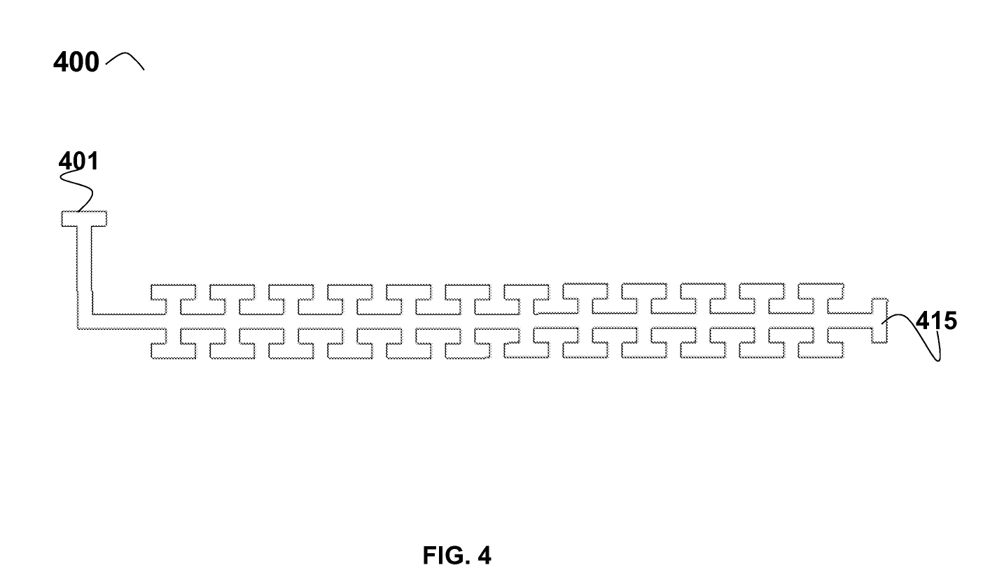

FIG. 3 represents a detailed sectional view of one of a perpendicular connector panel 300. The perpendicular connector panel 300 includes a protruding locking element 314, attached to the edge of the panel at a straight (180 degrees) angle. The perpendicular connector panel 300 also includes a plurality of slots 313, fitted to the size of the protruding locking element 314. FIG. 4 is a schematic prospective view of a parallel connector panel 400 for use in a system for the compartmentalization of object carrying cabins, in accordance with an exemplary embodiment. The parallel connector panel 400 includes a perpendicular connector 401 and a parallel connector 415 at the ends of the parallel connector panel. The perpendicular connector 401 is attached to the panel at a right (90 degree) angle, whereas the parallel connector 415 is attached to the panel at a straight (180-degree angle). Accordingly, the specification and drawings are to be regarded in an illustrative rather than a restrictive sense.

What I claim is:

1. A system used for compartmentalization of object carrying cabins, comprising:
a first plurality of perpendicular connector panels terminating at straight protruding locking elements for interlocking with further panels in a substantially perpendicular arrangement;
a second plurality of parallel connector panels terminating at right angled protruding locking elements for interlocking with the further panels in a substantially parallel arrangement;
wherein both sides of each panel in the first plurality of panels and the second plurality of panels include a plurality of slots for interlocking with the straight protruding elements and the right angled protruding element in the substantially perpendicular and parallel arrangements, respectively; and
wherein the further panels are selected from the first and second pluralities of panels.

2. The system of claim 1, wherein the perpendicular and parallel connector panels have two sides, each side having at least one slot.

3. The system of claim 1, wherein the system for compartmentalization of object carrying cabins is configured to provide a structure in a trunk of a vehicle, drawer, or other space.

4. The system of claim 1, wherein the one system used for compartmentalization of object carrying cabins is to minimize shifting of items in a trunk during travel or minimize the movement of items in a drawer when being opened or closed.

5. The system of claim 1, wherein the perpendicular connector panels and the parallel connector panels are assembled to provide a number of compartments and compartment sizes selected by a user.

6. The system of claim 1, wherein the perpendicular and parallel connector panels are made of a rigid material.

7. The system of claim 1, wherein a connector panel includes one or more slots on both sides and the connector panel terminates at one or two locking mechanisms.
